(19) United States
(12) Patent Application Publication
(10) Pub. No.: US 2019/0096435 A1
(43) Pub. Date: Mar. 28, 2019

(54) Magnetic Recording Method

(71) Applicant: Kaizhong Gao, North Oaks, MN (US)

(72) Inventor: Kaizhong Gao, North Oaks, MN (US)

(21) Appl. No.: 15/294,231

(22) Filed: Oct. 14, 2016

(51) Int. Cl. G11B 5/55; G11B 5/60; G11B 5/31; G11B 5/48; G11B 7/122; G11B 13/08; G11B 13/04

(52) U.S. Cl. CPC G11B 5/5578; G11B 5/5526; G11B 5/6088; G11B 5/314; G11B 13/04; G11B 5/607; G11B 7/122; G11B 13/08; G11B 5/4866

(57) ABSTRACT

A magnetic recording method, system and apparatus are described to increasing areal density capability (ADC) for a data storage system, where in different data tracks were written with different write configurations or with different writers in a particular way that is optimized to improve areal density for a data storage device. In an aspect, the data tracks were labeled as bottom, middle or top tracks, the write order follows in a particular way among different tracks, middle and top tracks partially trim the previously written track from one side. The distance between neighboring tracks, or the percentage of track trimmed, depend on the labels they have and the drive architecture used, are different. The particular write order can be in sequential or can have a certain level of randomness as set by the drive. The write order for each operation depend on the label determined by the drive for a given drive capacity requirement. For the apparatus to enable such approach, additional alignment condition between readers, writer, heater and temperature sensor are also optimized to improve performance, areal density and reliability.

### BACKGROUND OF THE INVENTION

### Field of the Invention

The present invention relates to a magnetic recording method, system and apparatus for increasing areal density capability (ADC), data rate and reliability for a magnetic data storage system.

Magnetic data storage systems are utilized in a wide variety of devices in both stationary and mobile computing environments. Magnetic storage systems include hard disk drives (HDD), and solid state hybrid drives (SSHD) that combine features of a solid-state drive (SSD) and a hard disk drive (HDD). Examples of devices that incorporate magnetic storage systems include desktop computers, portable notebook computers, portable hard disk drives, servers, network attached storage, television set top boxes, digital cameras, digital video cameras, video game consoles, and portable media players, etc.

These numerous devices utilize magnetic storage systems for storing and retrieving digital information. Storage density is a measure of the quantity of digital information that can be stored on a given length of track, area of surface, or in a given volume of a magnetic storage medium. Higher density is generally more desirable since it allows greater volumes of data to be stored in the same physical space. Density generally has a direct effect on performance within a particular medium. Increasing the storage density of disks requires technological advances and changes to various components or storage subsystem of a hard disk.

### BRIEF DESCRIPTION OF THE DRAWINGS

The foregoing aspects and many of the attendant advantages described herein will become more fully understood from the detailed description and the accompanying drawings. The drawings constitute a part of this specification and include exemplary embodiments of the invention, which may be embodied in various forms. It is to be understood that in some instances, various aspects of the invention may be shown exaggerated or enlarged to facilitate an understanding of the invention; therefore, the drawings are not necessarily to scale. In addition, in the embodiments depicted herein, like reference numerals in the various drawings refer to the conceptual design or structural elements represent each particular component or element of the apparatus.

FIG. 1 is a top plan view of a disk drive data storage system in which embodiments are useful;

FIG. 2A is a top plan view of media tracks written by shingled magnetic recording configuration;

FIG. 2B is a top plan view of media tracks written by interlaced magnetic recording configuration;

FIG. 2C is an illustration of a perspective view of a heat assisted magnetic recording (HAMR) head including a radiation source heating a media track, as can be used in data storage devices;

FIG. 2D is an illustration of a cross section view of a perpendicular recording (PMR) head used in data storage devices;

FIG. 2E is an illustration of another view of a perpendicular recording head from the media or air bearing surface (ABS) used in data storage devices;

FIG. 2F is an illustration of top down view of a perpendicular recording head write pole tip and yoke layer view from the down track direction used in data storage devices;

FIG. 3A-3E are top plan view of media written tracks with one of the blocked magnetic recording configurations, in an embodiment;

FIG. 3F-3I are top plan view of media written tracks with one of the blocked magnetic recording configurations, in an embodiment;

FIG. 3J is the top plan view of media written tracks with one of the blocked magnetic recording configurations, where the top tracks can be written narrower than middle and bottom tracks, in an embodiment;

FIG. 3K is the top plan view of media written tracks with one of the blocked magnetic recording configurations, where a top track, the middle tracks and a bottom track forms a data band x, in an embodiment;

FIG. 3L is the top plan view of media written tracks with one of the blocked magnetic recording configurations, where a top track, the middle tracks and a bottom track forms a data band x. Another top track, the middle tracks and a bottom track, forms another data band y, where in the top tracks from both bands partially overlaps to each other, the data band y is written after the data band x, in an embodiment;

FIG. 3M is the top plan view of media written tracks with one of the blocked magnetic recording configurations, where a top track, the middle tracks and a bottom track forms a data band x. Another top track, the middle tracks and a bottom track, forms another data band y, where in the top tracks from both bands partially overlap to each other, the data band x is written after the data band y, in an embodiment;

FIG. 3N is the top plan view of media written tracks with one of the blocked magnetic recording configurations, where a top track, the middle tracks and a bottom track forms a data band x. Another top track, the middle tracks and a bottom track, forms another data band y, where in the bottom tracks from both bands partially overlaps to each other, the data band y is written after the data band x, in an embodiment;

FIG. 3O is the top plan view of media written tracks with one of the blocked magnetic recording configurations, where a top track, the middle tracks and a bottom track forms a data band x. Another top track, the middle tracks and a bottom track, forms another data band y, where in the bottom tracks from both bands partially overlap to each other, the data band x is written after the data band y, in an embodiment;

FIG. 4 is a top plan view of media and tracks used with a disk drive data storage system, in an embodiment;

FIG. 5 is a flow diagram illustrating a method for blocked magnetic recording, in an embodiment;

FIG. 6 is a flow diagram illustrating a method or process for blocked magnetic recording system, and rewriting of existing data, in an embodiment;

FIG. 7 is a sectional view representation illustrating components of a system that executes methods of an embodiment;

FIG. 8A is an air bearing surface (ABS) view of a perpendicular recording head components of a system that executes methods of an embodiment;

FIG. 8B is an illustration of the heater and writer coil electric contact method that executes methods of an embodiment;

FIG. 9A is an ABS view of another perpendicular recording head components of a system that executes one of the preferred methods of an embodiment;

FIG. 9B is an ABS view of another perpendicular recording head components of a system that executes an embodiment; and

FIG. 9C is an ABS view of a HAMR head components of a system that executes an embodiment.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE PREFERRED EMBODIMENTS

In the following description, numerous specific details are disclosed to provide a thorough understanding of embodiments of the method, system and apparatus. One skilled in the relevant art will recognize, however, that embodiments of the method, system and apparatus described herein may be practiced without one or more of the specific details, or with other electronic devices, methods, components, and materials, and that various changes and modifications can be made while remaining within the scope of the appended claims. In other instances, well-known electronic devices, components, structures, materials, operations, methods, process steps and the like may not be shown or described in detail to avoid obscuring aspects of the embodiments. Embodiments of the apparatus, method and system are described herein with reference to figures.

Reference throughout this specification to “one embodiment,” “an embodiment,” or similar language means that a particular feature, structure, electronic device, method or characteristic described in connection with the embodiment is included in at least one embodiment. Thus, appearances of the phrases “in one embodiment,” “in an embodiment,” and similar language throughout this specification may refer to separate embodiments or may all refer to the same embodiment. Furthermore, the described features, structures, methods, electronic devices, or characteristics may be combined in any suitable manner in one or more embodiments.

With the numerous devices currently utilizing magnetic storage systems, hard disk drive (HDD) performance demands and design needs have intensified, including a need for increased storage density. There is an ongoing effort within the HDD industry to increase memory storage capacity while maintaining the same external drive form factors. Areal density is a measure of the number of bits that can be stored in a given unit of area, usually expressed in bits per square inch (BPSI). Being a two-dimensional measure, areal density is computed as the product of two one-dimensional density measures, namely linear density and track density. Linear Density is a measure of how closely bits are situated within a length of track, usually expressed in bits per inch (BPI), and measured along the length of the tracks around a disk. Track Density is a measure of how closely the concentric tracks on the disk are situated, or how many tracks are placed in an inch of radius on the disk, usually expressed in tracks per inch (TPI). The current demand for larger memory storage capacity in a smaller dimension is therefore linked to the demand for ever increasing storage track density.

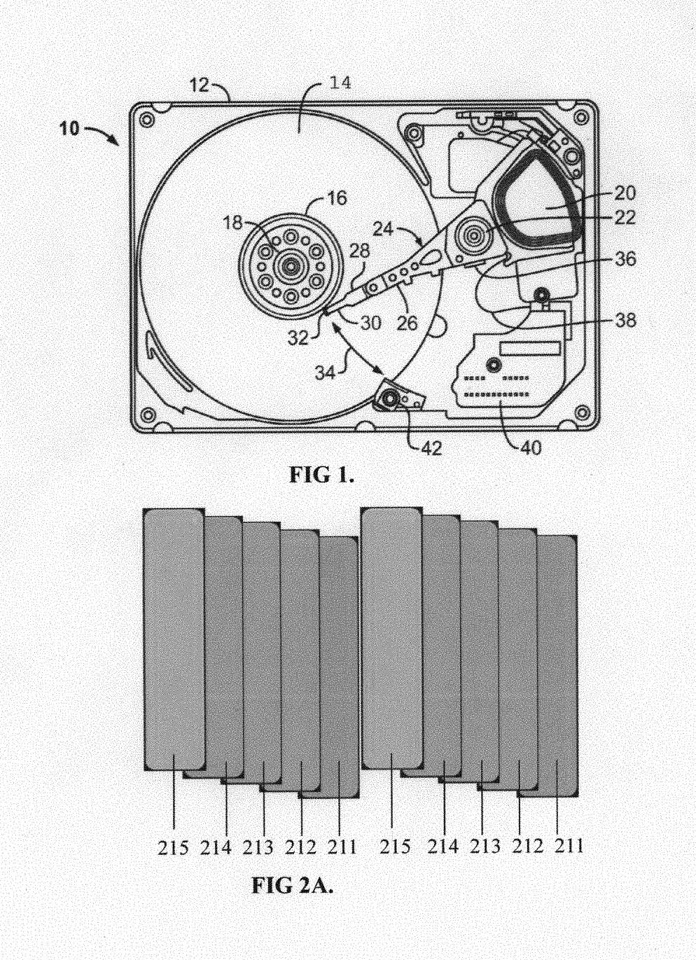

Referring to the figures wherein identical reference numerals denote the same elements throughout the various views, FIG. 1 illustrates a disk drive storage system 10, in which embodiments are useful. Features of the discussion and claims are not limited to this particular design, which is shown only for purposes of the example. Disk drive 10 includes base plate 12 that may be disposed on a top cover forming a sealed environment to protect internal components from contamination. Disk drive 10 further includes one or more data storage disks 14 of computer-readable data storage media. The disks are generally formed of two main substances, namely, a substrate material that gives it structure and rigidity, and a magnetic media coating that holds magnetic impulses or moments that represent data. Typically, both of the major surfaces of each data storage disk 14 include a plurality of concentrically disposed tracks for data storage purposes. Each data storage disk 14 is mounted on a hub or spindle 16, which in turn is rotatably interconnected with a base plate 12 and/or cover. Multiple data storage disks 14 are typically mounted in vertically spaced and parallel relation on the spindle 16. A spindle motor 18 rotates the data storage disks 14 at an appropriate rate.

The disk drive 10 also includes an actuator arm assembly 24 that pivots about a pivot bearing 22, which in turn is rotatably supported by the base plate 12 and/or cover. The actuator arm assembly 24 includes one or more individual rigid actuator arms 26 that extend out from near the pivot bearing 22. Multiple actuator arms 26 are typically disposed in vertically spaced relation, with one actuator arm 26 being provided for each major data storage surface of each data storage disk 14 of the disk drive 10. Other types of actuator arm assembly configurations may be utilized as well, such as an assembly having one or more rigid actuator arm tips or the like that cantilever from a common structure. Movement of the actuator arm assembly 24 is provided by an actuator arm drive assembly, such as a voice coil motor 20 or the like. The voice coil motor (VCM) 20 is a magnetic assembly that controls the operation of the actuator arm assembly 24 under the direction of control electronics 40.

A suspension 28 is attached to the free end of each actuator arm 26 and cantilevers therefrom. The slider 30 is disposed at or near the free end of each suspension 28. What is commonly referred to as the read/write head (e.g., transducer) is mounted as a head unit 32 under the slider 30 and is used in disk drive read/write operations. As the suspension 28 moves, the slider 30 moves along arc path 34 and across the corresponding data storage disk 14 to position the head unit 32 at a selected position on the data storage disk 14 for the disk drive read/write operations. The read/write head senses and/or changes the magnetic fields stored on the disks. Perpendicular magnetic recording (PMR) involves recorded bits that are stored in a generally planar recording layer in a generally perpendicular or out-of-plane orientation. A PMR read head and a PMR write head are usually formed as an integrated read/write head on an air-bearing slider. When the disk drive 10 is not in operation, the actuator arm assembly 24 may be pivoted to a parked position utilizing ramp assembly 42. The head unit 32 is connected to a preamplifier 36 via head wires routed along the actuator arm 26, which is interconnected with the control electronics 40 of the disk drive 10 by a flex cable 38 that is typically mounted on the actuator arm assembly 24. Signals are exchanged between the head unit 32 and its corresponding data storage disk 14 for disk drive read/write operations.

The data storage disks 14 include a plurality of embedded servo sectors each comprising coarse head position information, such as a track address, and fine head position information, such as servo bursts. The written in servo information typically were done within the drive factory during the manufacture process. There are two ways of write servo information, one use special head and machine to write before put the disk together, another way is to use recording head after drive assembly complete. As the head 32 passes over each servo sector, a read/write channel processes the read signal emanating from the head to demodulate the position information. The control circuitry processes the position information to generate a control signal applied to the VCM 20. The VCM 20 rotates the actuator arm 26 in order to position the head over a target track during the seek operation, and maintains the head over the target track during a tracking operation. The head unit 32 may utilize various types of read sensor technologies such as anisotropic magnetoresistive (AMR), giant magnetoresistive (GMR), tunneling magnetoresistive (TMR), other magnetoresistive technologies, or other suitable technologies.

There is an ongoing effort within the magnetic recording industry to increase memory storage capacity. To increase areal density beyond conventional magnetic recording media designs, smaller bits may be used, but this can cause thermal instabilities. To avoid this, media with high magneto-crystalline anisotropy (Ku) may be used. However, increasing Ku also increases the coercivity of the media, which can exceed the write field capability of the write head. Since it is known that the coercivity of the magnetic material of the recording layer is temperature dependent, one method to address thermal stability and increased coercivity is using heat-assisted magnetic recording (HAMR), wherein high-Ku magnetic recording material is heated locally during writing by the write head to lower the coercivity enough for writing to occur, but where the coercivity/anisotropy is high enough for thermal stability of the recorded bits at the ambient temperature of the disk drive (e.g., the normal operating or “room” temperature of approximately 15-30° C.). In some HAMR systems, the magnetic recording material is heated to near or above its Curie temperature. The recorded data is then read back at ambient temperature by a conventional magnetoresistive read head, e.g., a giant magnetoresistance (GMR) or tunneling magnetoresistance (TMR) based read head.

One type of HAMR disk drive uses a laser source and an optical waveguide coupled to a transducer, e.g., a near-field transducer (NFT), for heating the recording material on the disk. A near-field transducer is an optical device with subwavelength features used to concentrate the light delivered by the waveguide into spot smaller than the diffraction limit and at distance smaller than the wavelength of light. In a HAMR head, the NFT is typically located at the air-bearing surface (ABS) of the slider that also supports the read/write head, and rides or “flies” above the disk surface while creating an optical spot on the disk.

In conventional recording, media tracks are accessed for writing in random order to increase rewrite speed. However, the track density may be limited by adjacent track interference (ATI) in which a newly written track can cause erasure and/or loss of signal to noise ratio (SNR) to adjacent tracks. With HAMR, the ATI problem is especially significant since the heated spot can significantly expand into an adjacent track, softening the magnetic material such that fringe fields, including weak fringe fields, can cause serious track erasure. Generally, writeability (or the write field), the write field gradient in down track and cross track directions, the transition curvature and ATI limit perpendicular magnetic recording for a given head and media design. Due to limits in writeability, the media grain size cannot be further reduced as it approaches to thermal stability limit. For HAMR, the media grain size can be further reduced as described earlier. For HAMR, the effective field gradient, dominated by temperature gradient in media, along down track and cross track directions, transition curvature and ATI limits its ADC potential.

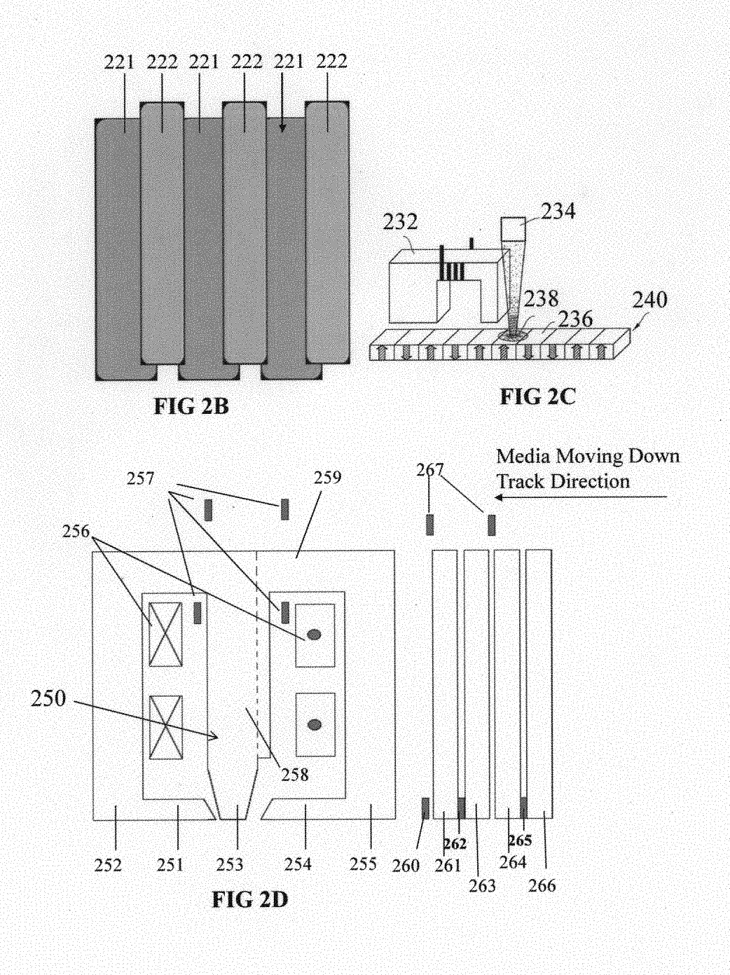

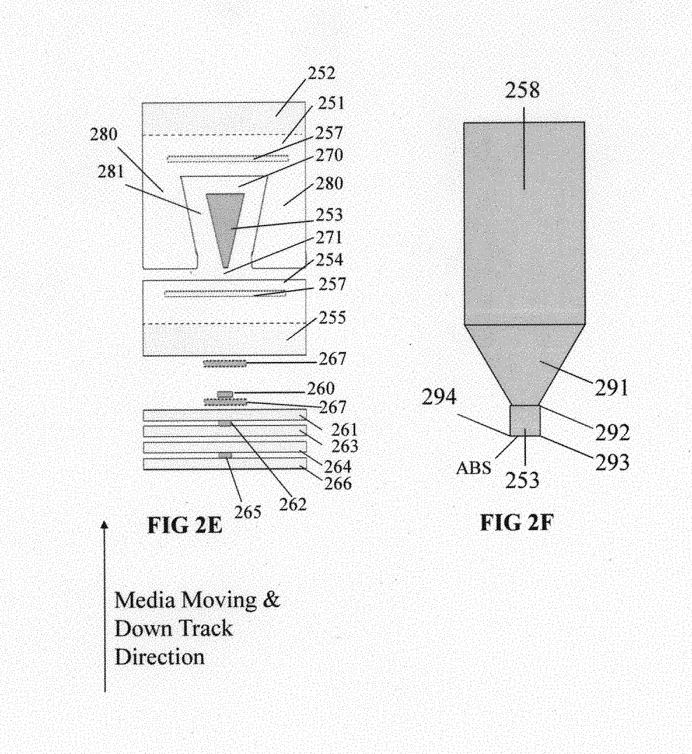

FIG. 2A shows a top plan view of media tracks written by shingled magnetic recording (SMR) configuration. In this approach, all tracks are written of equal width, the bottom tracks 211 are written before middle tracks 212, 213 and 214, and the top tracks 215 are written after middle tracks 214 are written. The combined bottom, middle and top tracks together is labeled as a band. During the write process, each track, except the top track, write wide and in such a way partially overlap with the previously written track or defined as partially “trim” the previous written track and enables a higher track density or TPI. The very last track, here defined as the top track 215 will be written after all middle tracks 212, 213, 214 were written. Between bands, there is a gap in between primarily due to the concern of ATI from the top track 215 of the next band, i.e. the top track 215 partially erase of the bottom track 211 of the next band. In the write process, since each of the bottom and middle track were only partially written once, the percentage of track pitch that is partially trimmed is substantially the same for all tracks except the top track, which will never be trimmed. This allow the write head position and read head position for a given data track to be kept at a fixed shift value. For example, the center of the track 211 defined by the writer is at the center of the write track 211. When 20% of track 211 were trimmed, in read back process, the reader will shift approximately 10% of the track pitch away from track 212 as the read track center with respect to the write track center. These writing configurations are determined and stored in drive memory. In this particular case, 5 tracks were used to form a band for illustration purpose. Due to last track is not trimmed, therefore it is written wide, an ADC penalty is taken for the last track write and will be averaged by the number of total tracks as the percentage of ADC penalty.

FIG. 2B shows a top plan view of media tracks written by interlaced magnetic recording (IMR) configuration. In this approach, the tracks are differentiated into bottom 221 and top 222 tracks. Each bottom track 221 is written before top tracks 222 on both side of the bottom tracks. The top tracks 222 will then be written between two bottom tracks, partially overwrite part of the bottom tracks. Here when use the earlier defined such partially overwrite of previous written track as “trim” the track. In IMR, each of the top tracks 222 trims the bottom tracks 221 from both sides. The top tracks 222 will not be trimmed. In this approach, the top tracks 222 are preferred to be written narrower than the bottom tracks 221 in order to improve the areal density. Unlike SMR, in IMR, there is no middle tracks. If the top track cannot be written narrower, then the potential areal density gain is limited. The bottom tracks 221 ADC gain is due to reduced transition curvature and an improved on-track gradient since it is written wide. While the gain for the top tracks 221 are due to removal of ATI.

FIG. 2C shows a portion of a magnetic recording assembly, as used in an embodiment. Ku and the coercivity of the media are increased using a technique such as HAMR, EAMR, or TAR. In the embodiment shown, radiation source 234 (e.g., a laser) is situated to heat localized regions of the media. When writing to the media, radiation source 234 situates a heat spot 238 on track 240 of the recording medium. Radiation source 234 is capable of supplying multiple levels of output heating power. A near-field transducer (NFT) is utilized for focusing electromagnetic energy from radiation source 234 to recording track 240. Read/write head 232 senses and/or changes the magnetic field of data bit 236 to write to the media with perpendicular or longitudinal magnetic orientation. In some approaches, various radiation sources other than a laser as typically used with HAMR may be used to heat the localized region of the media. The heating power is generated from a source other than a dynamic flying height (DFH) type slider in which the read/write head is surrounded by or adjacent to an embedded heating element that reduces local flying height can also be used.

FIG. 2D is an illustration of a cross section view of a perpendicular magnetic recording (PMR) head used in data storage devices, where in read and write operations, the media is under the head (lower side of the chart). A complete head has a writer 250, one or more readers (261-263 and 264-266), one or more heaters (257 and 267) and a temperature sensor 260. In this particular example, two readers (261-263 and 264-266) are shown. Each reader has an TMR read sensor stack (or sensing element) and two shields. Reader 1 consists of a bottom shield 266, a sensing element (or called reader stack) 265 and a top shield 264. Reader 2 consists of a bottom shield 263, a reader sensing element 262 and a top shield 261. In read back operation, bias current go through the read sensor sensing element, the magnetic flux from media bit cause rotation of the magnetic layer within the sensing element and lead to a change in resistance. This change in resistance is converted into signal and eventually allow drive to determine the magnetization state of each individual bits on disk.

The reader shields not only help to improve read sensing element spatial resolution, but also act as the leads for reader bias current. When adding more than one readers in the playback process, noise cancellation can be done efficiently, including cancellation of inter symbol interference (ISI) or inter track interference (ITI), thus leads to an improved SNR for a given written transition pattern and result in a better ADC capability. Since each read sensor is operated independently, each sensor needs to have its own shield in order to boost SNR and improve resolution. In the meantime, a separate circuit loop is needed in order to obtain playback waveform out of each individual layer.

A temperature sensor 260 is typically placed next to the read sensor exposed at or near ABS. The signal from temperature sensor enable drive to determine the dynamic flying height of the recording head on top of the media in read and write operations. More importantly, the contact event is also detected. When in contact, the friction heating will cause temperature sensor 260 to have significant change in resistance or output signal. Since the detection needs to be correlated to read and write operation, the preferred implementation is to have such temperature sensor to be close to reader and writer.

The write head 250 typically has a trailing (251 and 252) and a leading (254 and 255) shields, a write pole tip 253, yoke 258 and via 259. The write coils 256 current applied in different directions to energize the writer to produce the magnetic write field. The writer heater typically located in one of the locations shown in place labeled 257. In the write process, the writer heater 257 is energized, push the write pole tip 253 to be closer to the media. Then the write coil 256 current helps to let the magnetic write pole tip 253 to saturate and generates a large magnetic write field. In playback, the reader heater located in one of the places labeled as 267, is energized, and pushes the readers (261-263 and 264-266) to be in close point with respect to the media ensure best SNR.

In both read and write processes, a small current is applied to the temperature sensor 260, the feedback from the temperature sensor 260 can be used to determine the head to media physical separation and feedback to the applied current used in heaters (257 and 267). Thus help the head to maintain a constant small flying height below 3 nm, but stable during the read and write processes.

FIG. 2E is an illustration of another view of a perpendicular recording head from the media or ABS used in data storage devices. The typical perpendicular write head has a front shield 251 and 252 (also called the trailing shield), a leading shield 254 and 255, and both sides has a side shield 280. Most shield materials are high moment soft magnetic materials such as CoFe or CoNiFe alloys and typically the front shield 251 and side shields 280 are connected to each other as can be seen from the ABS. The separation between front shield 251 and the write pole 253 labeled as 270 is a front shield gap. The separation between the write pole 253 and side shield 280 is the side shield gap 281. The angle of the write pole edge 253 with respect to the media moving down track direction is defined as magnetic wall angle for the write pole. The typical reader and writer heaters (257 and 267) locations are marked with a dashed line. Note that only one of the locations for reader heater and writer heater respectively is used for a given design. The shaded area (252, 255, 261, 263, 264, 266) represents the shields extended into ABS to the back. Although the drawing is not to scale. The relative location between different components: writer, readers, heaters and temperature sensor can be illustrated clearly. Here in we use the write pole 253 to represent writer location, reader sensor junction area 262 and 265 to represent readers' location, heater heating element (257 or 267) to represent heaters location and temperature sensor active element 260 to represent temperature sensor location and use this to determine the arrangement or architecture between these components to form the recording head of the embodiments.

FIG. 2F is an illustration of top down view of a perpendicular recording head write pole tip 253 and yoke 258 layer view from the down track direction used in data storage devices. The magnetic write pole 253 typically on order of a few tenths of nanometers has a much smaller dimension as compare to the yoke 258, typically with approximately several micro meters wide. The connection in between is typically labeled as neck region 291. The distance between 292 and 293 which expose at the ABS is called write pole break point. In actual process, the break point is defined by photo mask layout, the finished head will have smooth surface. The back of the yoke 258 away from ABS is magnetically connected to the via. The width of the write pole is the distance between 294 and 293. In actual process, the shape of the yoke and write pole is defined with smooth curve due to lithographic limitation. In design process, FIG. 2F illustrate the basic concept and draft. The actual head will have smooth shape after the head is made. However, the definition of the recording head parameters are the same.

In HAMR, the laser power or the writer coil current configurations are used to determine the write width and to optimize for SNR, this write configuration including: laser power, laser current waveform, heater current and waveform, write current, write current overshoot and write current overshoot duration. For PMR, the write width is more or less fixed by the write pole width. The write current, heater current and waveform, write current overshoot and current overshoot duration are the primary write configuration that needs to be optimized for ADC, drive performance and reliability.

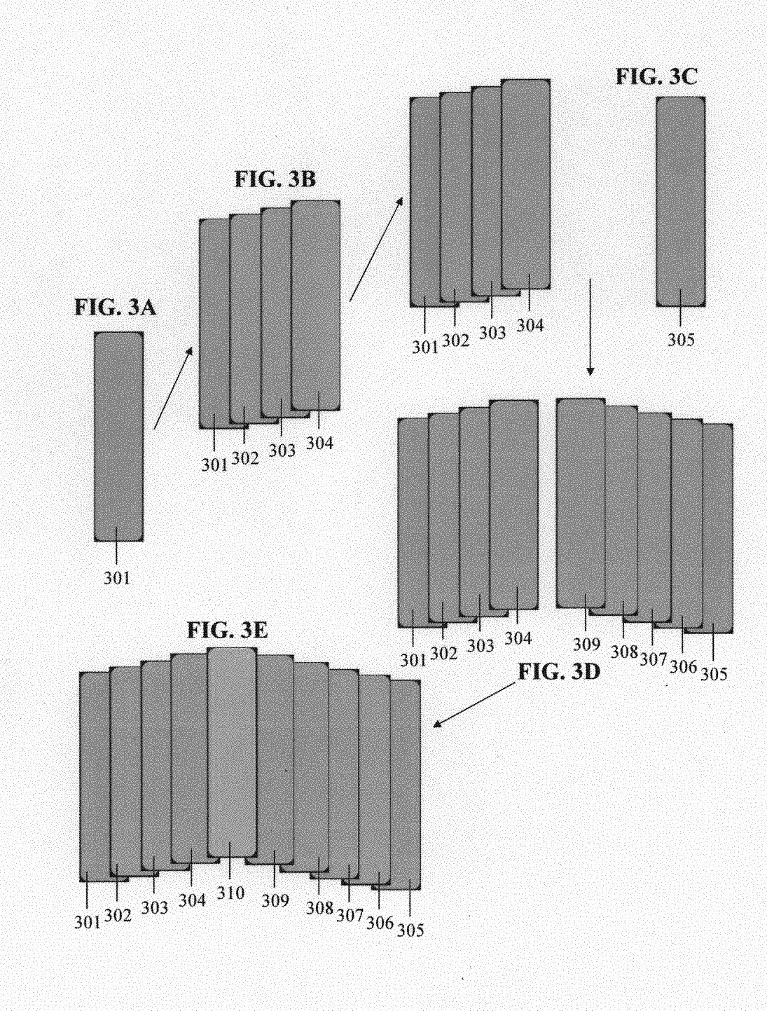

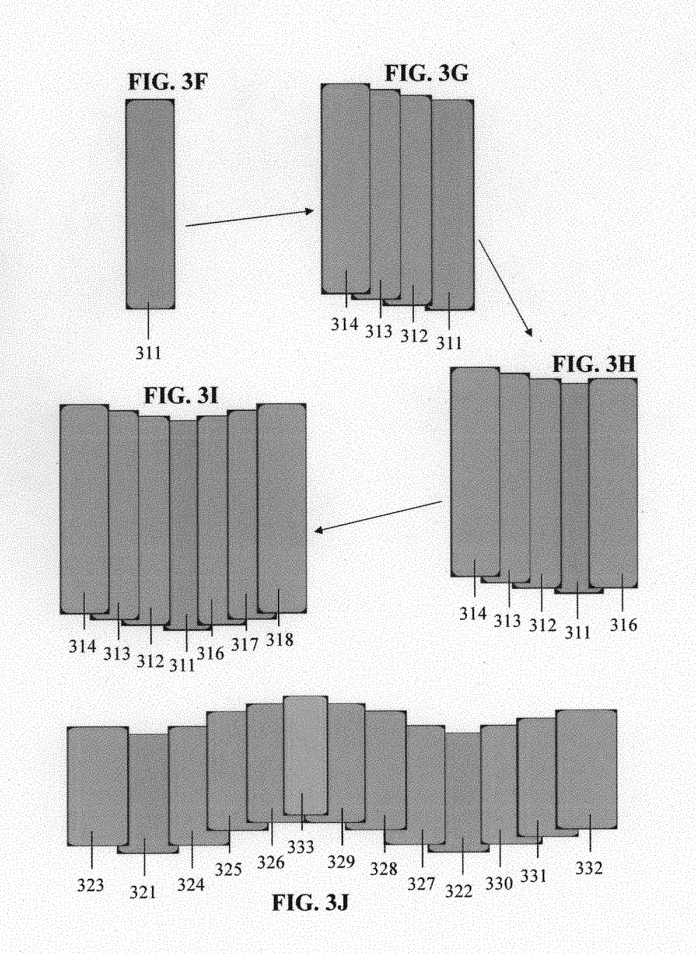

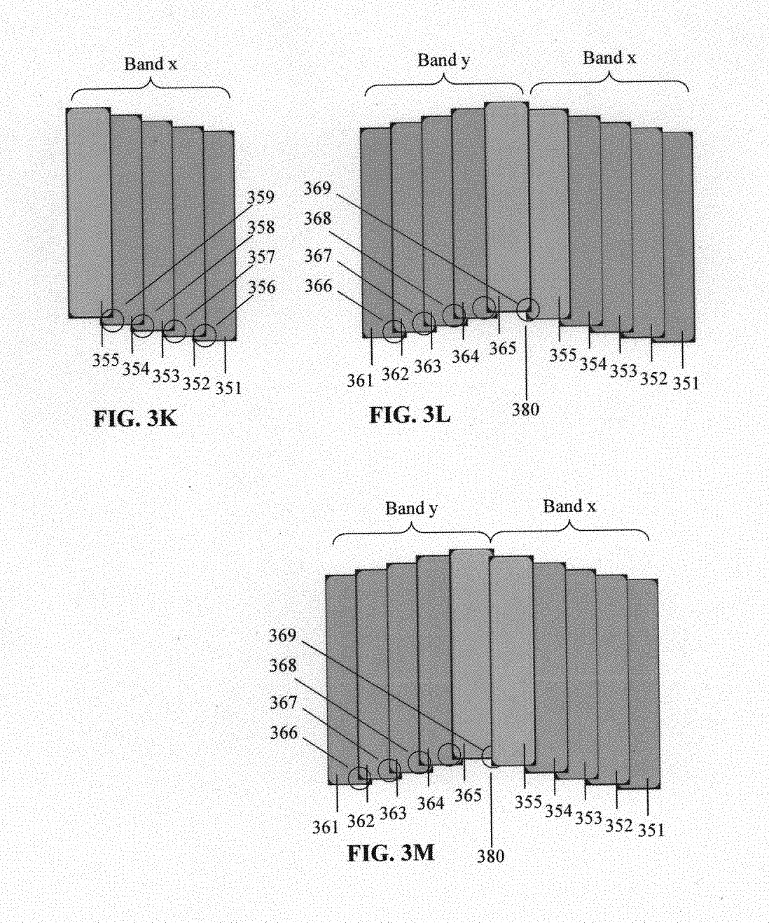

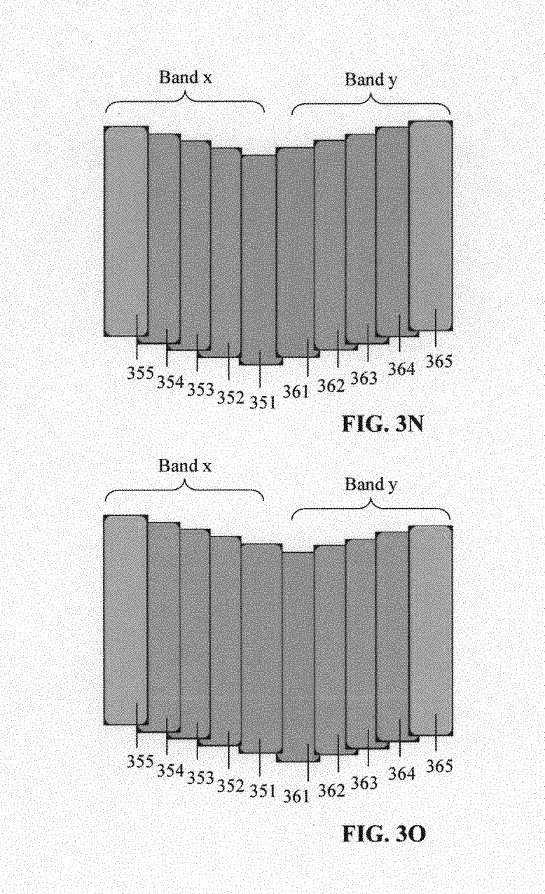

FIG. 3A-3E are top plan view of the media written tracks with one of the blocked magnetic recording configurations, in an embodiment. The data tracks utilized here can be labeled into bottom (301 and 305), middle (302-304 and 306-309) and top track 310 for a given data region. For each new write, the bottom track 301 is written first (FIG. 3A), then the middle tracks 302, 303 and 304 were written in such a way that each new middle track is partially trim the previous written track (such as 302 trim 301, 303 trim 302 and 304 trim 303) from one side, until all middle tracks are written (FIG. 3B). For more data, another bottom track 305 is written (FIG. 3C), then middle tracks (306, 307, 308,309) until all middle tracks are written, and each track partially trim the previously written track (FIG. 3D). When both sides of the middle tracks (302-304 and 306-309) are fully written, the top track 310 is written in such a way that the top track trims both side of the top middle tracks (304 and 309) partially by an approximately equal amount (FIG. 3E).

FIG. 3F-3I are top plan view of the media written tracks with another blocked magnetic recording configuration, in another embodiment. The data tracks utilized here are labeled into bottom 311 and middle 312-318 tracks for a given data region. For this particular embodiment, we focus on how to optimize for the bottom tracks, therefore, the top track is not shown here. For each new write, the bottom track 311 is written first (FIG. 3F), then the middle tracks 312, 313 and 314 are written in such a way that each new middle track partially trims the previous written tracks (such as 312 trim 311, 313 trim 312 and 314 trim 313) from one side, until all middle tracks are written (FIG. 3G). For more data, the middle tracks 316, 317 and 318 are written in such a way that each new middle track partially trims the previous written track from the other side (such as 316 trim 311 other side as FIG. 3H), until all middle tracks are written (FIG. 3I). In one embodiment, the bottom track 311 is trimmed on both sides by middle tracks 312 and 316, each of the middle track is only trimmed on one side. The percentage of track width being trimmed for the bottom track is smaller than the percentage of track width being trimmed for the middle tracks. In an embodiment, the linear density among bottom, middle and top tracks are substantially same. In another embodiment, the linear density among bottom, middle and top tracks are different.

In an embodiment, the bottom and middle track width are substantially equal to each other after being trimmed, such as tracks 311, 312, 313 and 314 have the same width. The written in track position between neighboring tracks are shifted in different value from bottom tracks to different middle tracks, such as the spacing between center of track 311 to track 312 is larger than the spacing between center of track 312 to track 313. The relative spacing between bottom track center 311 to the first middle track (312) center is higher than the first middle track (312) center to the second middle track (313) center. The relative spacing between the first middle track 312 center to the second middle track 313 center is approximately same as the spacing between the second middle track 313 center to the third middle track 314 center. In the case on one side there is no middle track, the spacing between top and bottom track centers are larger than the spacing between two neighboring middle tracks or the last middle track to the next top track.

FIG. 3J is the top plan view of the media written tracks with one of the blocked magnetic recording configurations, where the top tracks can be written narrower than middle and bottom tracks, in another embodiment. The write process follows above rules set by blocked magnetic recording configuration as shown in FIG. 3A-3I, where the bottom tracks (321 and 322) were written before the middle tracks (323-332), the middle tracks (323-332) were written, partially trim the previous written track from one side. The bottom tracks (321 and 322) are trimmed from both sides. The top track 333 is written after both sides of the top middle tracks (326 and 329) are written and is written in such a way the top track 333 trims the opposite sides of neighboring middle tracks (326 and 329). Note that in drive operation, each individual track can have separate data set or through optimization, a large block of data can be packed together. The top track is written narrower than the middle and bottom tracks. In HAMR, this can be done using one head by adjusting laser or write current configuration as stated earlier. In PMR, this can be done using recording head with two writers, with each writer to optimize write current configurations (write current amplitude, writer heater current and waveform, write current overshoot and overshoot duration). In addition, other energy assisted method can be used such as in microwave assisted magnetic recording (MAMR) by changing bias current in spin torque oscillator (STO), or in wire assisted magnetic recording by changing the bias current in assisted wire are also the method to achieve a writing with different write width using a single writer.

Note that as long as the drive operation follows the basic rules set by the blocked magnetic recording, there are opportunities to improve ADC and performance in drive in a much flexible manner. In one embodiment, the written middle tracks do not have to follow all sequential order as set by SMR. As shown in FIG. 3J, the middle track 323 can be written before or after track 324 is written, as long as the bottom track 321 is written in first. In another embodiment, after both bottom tracks 321 and 322 are written, tracks 323, 324, 327 and 330 can be written in any order, some (such as track 323 and 330) can be written after the top track 333 is written. In other words, this approach enables certain level of random access or flexibility for drive operation.

In an embodiment, control circuitry sets predetermined values for HAMR including: track pitch, laser power, linear density, write current, current overshoot, overshoot duration and dynamic flying height or writer heater etc., for top, middle and bottom tracks. In addition, the recording configurations stored also include the track position shift between write tracks relative to the read back final data tracks. Depend on the bottom, middle and top tracks, the relative shift of the written tracks position are different. In another embodiment, control circuitry sets predetermined values for PMR recording: track pitch, linear density, write current, current overshoot, overshoot duration and dynamic flying height etc. for top, middle and bottom tracks.

For the case the top tracks are with different track width using different heads, additional write configuration for each head and for each type of tracks needs to be stored in drive memory or data cache. These write configurations may vary from ID to OD, and also may depend on drive ambient temperature, pressure and other conditions, will be stored in drive memory or data cache. For example, in one embodiment, the write configurations may vary by zone, for each zone, the write configurations for top, middle and bottom tracks will need to be stored.

In one embodiment, the write configurations are determined before the drive ship to customers, during the factory test process. The write configuration is stored in drive. During the drive operation in the field, after the customer use the drive, the optimal operation condition may change over time. One of the embodiments here includes monitor of possible data failure and drive re-optimization of the writing configuration for top, middle and bottom tracks, and over time to adjust the write configuration to help to reduce the drive failure.

In one embodiment, a drive includes recording method of BMR and SMR. The recording media have separate regions or zones for BPM and SMR separately. In one embodiment, a drive includes recording method of BMR and conventional recording. The recording media have separate regions or zones for BPM and conventional recording. In one embodiment, the drive includes different BMR configurations, such as BMR_{5,5}, BRM_{20,5} and BMR_{0,0} . . . In one embodiment, the drive include a mixture of BMR_{x,y}, with one or more of the SMR, IMR and conventional recording in any combination.

FIG. 3K is the top plan view of the media written tracks within a data band with one of the blocked magnetic recording configurations, in an embodiment. In this particular example, all data are packed into five tracks 351-355 within a band. The bottom track 351 is partially erased by the first middle track 352, here we define the percentage of track being partially erased or overlapped as x1%, noted as 356. As the whole band is complete written, track 353 partially erase track 352 by x2%, noted as 357, and track 354 partially erase track 353 by x3%, noted as 358, and track 355 partially erase track 354 by x4%, noted as 359. Since each track from 352 to 354 are only partially erased from one side for one time, the percentage of tracks being erased for each middle track is approximately the same. In other words, the target value of x2, x3 and x4 is approximately the same.

FIG. 3L is the top plan view of the media written tracks with a second data band with one of the blocked magnetic recording configurations, in an embodiment. The tracks on the new band includes bottom track 361, middle tracks 362, 363, 364 and top track 365. The new data are packed into five tracks 361-365 within a band. The bottom track 361 is partially erased by the first middle track 362, here we define the percentage of track being partially erased or overlapped as y1%, noted as 366. As the whole band written complete, track 363 partially erase track 362 by y2%, noted as 367, and track 364 partially erase track 363 by y3%, noted as 368, and track 365 partially erase track 364 by y4%, noted as 369. Since each track from 362 to 364 are only partially erased from one side for one time, the percentage of tracks being erased for each middle track is approximately the same. In other words, the target value of y2, y3 and y4 is approximately the same. In addition, such arrangement of middle tracks only being partially trimmed once from one side, therefore, the percentage of track being trimmed for all middle tracks is approximately same. In other words, the value of x2, x3, x4, y2, y3 and y4 are approximately the same. In an embodiment, top track 365 partially erase middle track 364 within the same band. The top track 365 also partially trim the top track of 355 from the other band. When trim by track 365, track 355 can be considered as the top middle track for BMR. On the other hand, track 355 can also be considered as the top track from band x. Since incoming data written requests are with certain level of randomness, in principle, one band y can be rewritten multiple times before neighboring band x being written. Therefore, there will be degradation due to ATI. One of the embodiment is to have percentage trimmed between track 365 and track 355, noted in 380 as z %, to be less than the previous trimmed percentage of tracks x or y. i.e. z is less than x2, x3, x4, y2, y3 and y4 in this case. In this embodiment, band y can be rewritten multiple times before band x has to be rewritten.

FIG. 3M is the top plan view of the media written tracks with a second data band with one of the blocked magnetic recording configurations, in an embodiment. The band x and band y both have a top track, the overlapped track portion (or partially trimmed value) as a percentage of track pitch between top tracks is less than the trimmed value between middle tracks. In this approach, both band x and band y can be rewritten multiple times with any given order, without have to worry ATI induced degradation since both top tracks were trimmed less than middle tracks, an additional SNR is built into top tracks. Note that the linear density of each track can be same or approximately same to each other.

FIG. 3N is the top plan view of the media written tracks with a second data band with one of the blocked magnetic recording configurations, in an embodiment. The band x and band y both have a bottom track 351 and 361 partially overlapped to each other. In this case, band x with track 351 is written before band y with track 361. The written track center of bottom track 351 is shifted further away with respect to the middle track 352 such that the distance between the written track center 351 to 352 is larger than the distance between the written track center 352 to 353. In other words, the bottom track 351 is trimmed less as compare to other middle tracks. For band y, the bottom track 361 is also trimmed less as compare to other middle tracks 362,363 and 364 within the same band. When two bands are both written in, two bottom tracks 351 and 361 overlaps with each other. The predetermined write configuration allows a partially trim for one over the other, in either way, in such a way that both tracks 351 and 361 can still recover data after the write for both bands. This can be achieved directly since the bottom tracks were trimmed from both side symmetrically, the on-track information are still kept. The overlapped track portion (or partially trimmed value) as a percentage of track pitch between bottom tracks is less than the trimmed value between middle tracks. In this approach, both band x and band y can be rewritten multiple times with any given order, without have to worry ATI induced degradation since both bottom tracks were trimmed less than middle tracks, and the information written along the center of the bottom tracks were kept, an additional SNR is built into bottom tracks. Note that the linear density of each track can be same or approximately same among bottom, middle and top tracks.

FIG. 3N is the top plan view of the media written tracks with a second data band with one of the blocked magnetic recording configurations, in an embodiment. The band x and band y both have a bottom track 351 and 361, can be partially overlapped to each other. In this case, the band x is written, the bottom track 351 can be directly written in along with other tracks. The band 361 is partially trimmed by both track 351 and the middle track 362 from its own band. Since the center of track 361 is shifted and the track pitch has been predetermined, both track 351 and track 362 will trim track 361 at a much smaller width as compare to the trimmed value between middle tracks. The good recording transition information along the bottom track 361 center are still kept with enough SNR/BER margin. In this approach, BMR can be used as an alternative to the SMR, but with much less ADC penalty and with higher data rate.

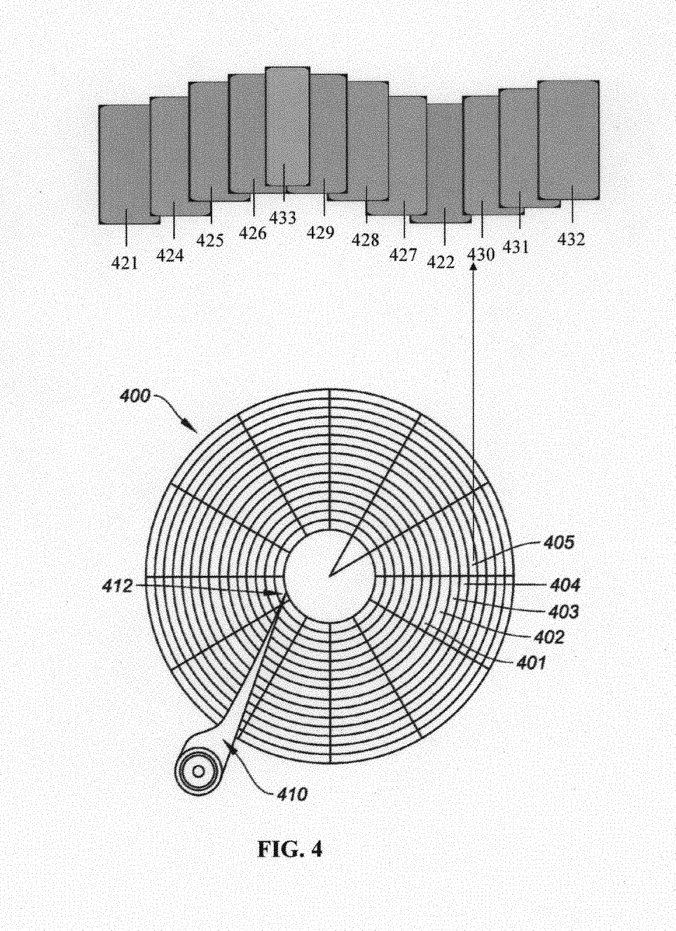

FIG. 4 illustrates a portion of a magnetic memory system including magnetic recording disk 400, actuator arm assembly 410, and read/write head 412. Magnetic recording disk 400 includes a plurality of concentric data tracks. In the example embodiment, data zones 401, 402, 403, 404 and 405 are located on disk, each may have a number of tracks.

In an embodiment, track 421 is written wide, followed by track 422, followed by track 424, 425,426, 427, 428, 429, 430, 431, 432 and followed by track 433. The write track width of track 421 and 422 can be larger than other tracks. The write width of track 433 can be smaller than other tracks. To achieve that, the write configurations in HAMR needs to be optimized, typically including adjust laser bias current, laser bias current waveform, writer current, writer current overshoot, writer current overshoot duration and heater current and waveform. In PMR, this includes optimization of write configurations for all write heads, if there are more than one writer in an integrated head, typically includes: writer current, writer current overshoot, writer current overshoot duration and heater current and waveform for each heads.

Alternatively, for the same amount of data that needs to be written in the same number of tracks, the write order can be different, such as: write track 421 first, followed by tracks 424, 425, 426, then followed by track 422, followed by tracks 427, 428, 429, 430, 431, 432 and finally write the track 433.

In an embodiment, the data rate and the linear density of the tracks 421, 422 is substantially the same as track 424, 425, 426, 427, 428, 429, 430, 431, 432, and also substantially the same as track 433. Here, the same data clock rate, disk rotation speed and dynamic fly height (DFH) may be used for different tracks. In this embodiment, the data clock rate, DFH, and record of track/data rate correspondence is maintained the same between tracks. Also, in an embodiment, the read channel does not have to differentiate between different tracks within the same zone.

In an embodiment, control circuitry sets predetermined values for different track pitch, linear density, write current, and dynamic flying height, for all tracks from 421 to 433. In HAMR this write configuration also includes laser current amplitude and laser current waveform.

In an alternative embodiment, bottom tracks 421 and 422 may have different data rate or linear density as compare to middle tracks 424, 425, 426 etc. In an alternative embodiment, bottom tracks 421 and 422 may have different data rate or linear density as compare to top track 433. In an alternative embodiment, top, bottom and middle tracks can all have different linear density and data rates.

In general approach, one can define the number of middle tracks between top and bottom tracks as the reference for different configurations of the blocked magnetic recording (BMR). For example, BMR_{3,3} stands for three middle tracks on each side of the bottom tracks, and is illustrated in FIG. 4. BMR_{0,0} becomes interlaced magnetic recording (IMR) as illustrated in FIG. 2B.

In an embodiment, the number of middle tracks on either side of the bottom or top tracks are same, such as BMR_{3,3} or BMR_{10,10}. In another embodiment, the number of middle tracks on either side of the bottom or top tracks are different. Such as BMR_{5,0}, BMR_{7,0}, BRM_{19,3}, etc. The number of middle tracks on either side of the bottom tracks can be varied from 0 to a large number, for example, 100. This number can be adjusted to optimize for drive capacity/performance requirement, depend on different application needs.

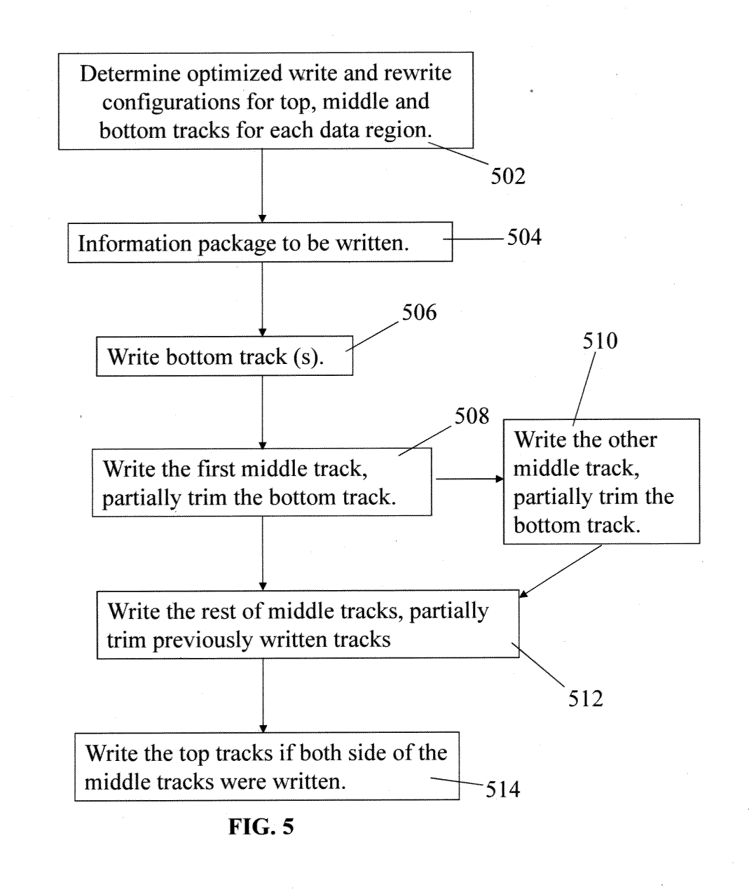

FIG. 5 illustrates a method and process for blocked magnetic recording using a technique such as PMR or HAMR. It will be understood that each step in the flowchart illustration can be implemented by computer program instructions, or in drive firmware. These computer program instructions may be provided to a processor of a programmable data processing apparatus, such that the instructions execute via the processor to implement the functions or actions specified in the flowchart. The instructions may be executed by controller. In an embodiment, the controller is a component of a HDD. In an alternative embodiment, the controller is separate from the HDD and may be connected to the HDD and communicate with the HDD.

As shown, in an embodiment, the drive first determines architecture and obtain optimized write and rewrite configurations for top, middle and bottom tracks for each data region as detailed in step 502. This is usually done at the factory as part of drive self-test or certify process before ship the drive product to customer. Here the region can be zone based, sector based, band based or another geometric unit as defined within each disk surface. Next, the information package is intended to be written to a magnetic storage disk is send to drive, as detailed in step 504. Next, as stated in step 506, write the bottom track or tracks based on the amount of data to be written. Then start to write on the middle tracks, as stated in 508. There are two approaches, write middle tracks immediately after write bottom track 508, or write both sides of first middle tracks before write other middle tracks 510. Then continue write other middle tracks sequentially as stated in 512 until all middle tracks are written, before write the top tracks, as stated in 514. The top tracks are written only after both sides of middle tracks are written. In the case the number of middle tracks is zero between top and bottom tracks on either side, the top tracks are written after the bottom or the upper most middle tracks are written.

In another embodiment, if the previous written data does not occupy all tracks in a band, the new data can be written continuously on the middle or top tracks as in step 508, 510, or 512. Each newly written track will partially trim the previous written track next to them, unless a new bottom track needs to be written.

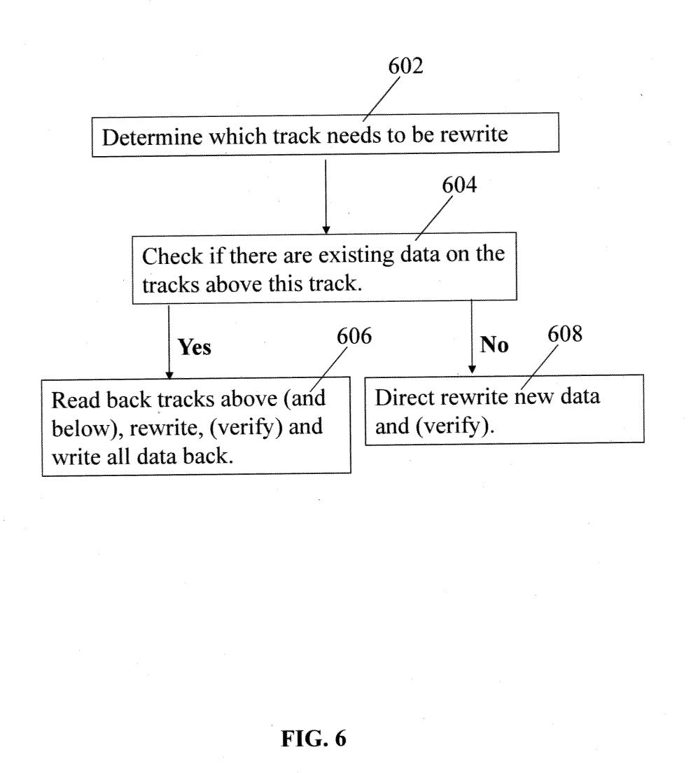

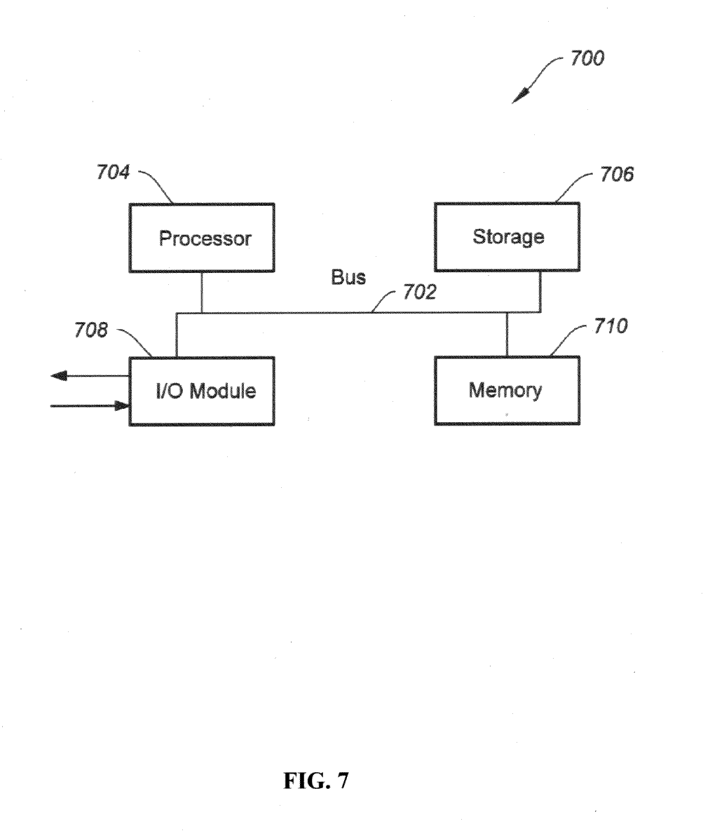

FIG. 6 illustrates a method and process for rewrite or update existing data using blocked magnetic recording system as needed, in an embodiment. As stated in step 602, the information requested to be updated or rewritten is determined and sent to drive. The drive will determine which track or tracks needs to be rewritten, here in defined as point of interest (poi) track. The drive will determine if there are any existing data that is still need to be stored on the tracks above the POI track that a rewrite is needed as stated in step 604. If the query of step 604 is answered positive, then the drive needs to read back the tracks above the POI track and store the data in cache or in drive memory, and then rewrite or write all updated information back to the tracks, follow the process as described in FIGS. 3-5 as stated in step 606. If the query of step 604 is answered negative, then the drive can write all updated information back to the tracks directly, follow the process as described in FIGS. 3-5 as stated in step 608. In another embodiment, the rewrite process 606 and 608 may include a verification process to reduce ATI induced BER loss. In one embodiment, read verification process is included to ensure data reliability. In another embodiment, the relevant BER degradation can be calibrated in drive given to different operation environmental conditions before the drives are shipped. In another embodiment, based on different operation conditions, after each write, a read verification process can be added. In such process, read back of previously written tracks are performed and the drive will determine if the BER with the blocked magnetic recording method is at an acceptable level. If the BER fall below certain threshold, then the rewrite is automatically triggered. In one embodiment, calibration process before the drive ship to customer is done and the write configuration for each drive at different environmental conditions should be built into drive, either stored on disk or at cache or memory. However, there still may occasionally have errors occur. In another embodiment, a build in firmware algorithm is included to make micro-adjustment to the write configuration after the drive shipped based on additional changes during the life time of the drive in service.

In another embodiment, any rewritten data or written in new data can start from any bottom tracks, the closest middle tracks where there are no previously written data and the top tracks where both sides of the middle tracks are written. Within those tracks, the access can be random.

Turning now to FIG. 7, components of system 700 are illustrated, in an embodiment. System 700 includes processor module 704, storage module 706, input/output (I/O) module 708, memory module 710, and bus 702. Although system 700 is illustrated with these modules, other suitable arrangements (e.g., with more or less modules) known to those of ordinary skill in the art may be used. For example, system 700 may be a logic implemented state machine or a programmable logic controller.

In an embodiment, the methods described herein are executed by system 700. Specifically, processor module 704 executes one or more sequences of instructions contained in memory module 710 and/or storage module 706. In one example, instructions may be read into memory module 710 from another machine-readable medium, such as storage module 706. In another example, instructions may be read directly into memory module 710 from I/O module 708, for example from an operator via a user interface. Information may be communicated from processor module 704 to memory module 710 and/or storage module 706 via bus 702 for storage. In an example, the information may be communicated from processor module 704, memory module 710, and/or storage module 706 to I/O module 708 via bus 702. The information may then be communicated from I/O module 708 to an operator via the user interface.

Memory module 710 may be random access memory, flash, part of the media or other dynamic storage device for storing information and instructions to be executed by processor module 704. In an example, memory module 710 and storage module 706 are both a machine-readable medium. In an embodiment, processor module 704 includes one or more processors in a multi-processing arrangement, where each processor may perform different functions or execute different instructions and/or processes contained in memory module 710 and/or storage module 706. For example, one or more processors may execute instructions for heating and writing to tracks, and one or more processors may execute instructions for input/output functions. Also, hard-wired circuitry may be used in place of or in combination with software instructions to implement various example embodiments. Thus, embodiments are not limited to any specific combination of hardware circuitry and software. Bus 702 may be any suitable communication mechanism for communicating information. Processor module 704, storage module 706, I/O module 708, and memory module 710 are coupled with bus 702 for communicating information between any of the modules of system 700 and/or information between any module of system 700 and a device external to system 700. For example, information communicated between any of the modules of system 700 may include instructions and/or data.

Circuit or circuitry, as used herein, includes all levels of available integration, for example, from discrete logic circuits to the highest level of circuit integration such as VLSI, and includes programmable logic components programmed to perform the functions of embodiments as well as general-purpose or special-purpose processors programmed with instructions to perform those functions. Machine-readable medium, as used herein, refers to any medium that participates in providing instructions to processor module 704 for execution. Such a medium may take many forms, including, but not limited to, non-volatile media, and volatile media. Non-volatile media includes, for example, optical or magnetic disks, such as storage module 706. Volatile media includes dynamic memory, such as memory module 710. Common forms of machine-readable media or computer-readable is media include, for example, floppy disk, a flexible disk, hard disk, magnetic tape, any other magnetic medium, a CD-ROM, DVD, any other optical medium, punch cards, paper tape, any other physical mediums with patterns of holes, a RAM, a PROM, an EPROM, a FLASH EPROM, any other memory chip or cartridge, or any other medium from which a processor can read.

In an embodiment, a non-transitory machine-readable medium is employed including executable instructions for writing to a data storage system. The instructions include code for heating the bottom track of a recording media with a first power using a radiation source, writing to the bottom track, heating the middle tracks of a recording media with a second power, writing to the middle tracks, heating the top track of a recording media with a third power, writing to the top track after both sides of middle tracks were written. The first and second power are higher power than the third power. In another embodiment, for HAMR write, the first and second power can be different, preferably the first power is higher than the second power and the second power is higher than the third power. In another embodiment, the first power and second power can be approximately equal to each other, and the third power is lower than the first and the second power. In another embodiment, the write current, current overshoot and overshoot duration is further optimized to write with different track width and improve ADC.

In an embodiment, the non-transitory machine-readable medium further includes executable instructions for writing to the top track at substantially the same data rate and linear density as the bottom track and the middle tracks. In an embodiment, the radiation source is a laser. In another embodiment, the non-transitory machine-readable medium further includes executable instructions for setting the first power and the second power at substantially a same power. In an embodiment, the non-transitory machine-readable medium further includes executable instructions for setting the third power in the range of about 4 percent to 30 percent less power than the first power and the second power.

In an embodiment, the non-transitory machine-readable medium further includes executable instructions for setting predetermined values for track pitch, heating power, linear density, write current, and dynamic flying height, for the bottom track, the middle tracks, and the top track. In an embodiment, the non-transitory machine-readable medium further includes executable instructions for recording or making available for recording up to about 50 percent of the total recording tracks utilizing substantially the same laser power as the third power, or utilizing a lower power than the first power and the second power when implementing BMR_{0,0}. In an embodiment, the non-transitory machine-readable medium further includes executable instructions for setting predetermined values for track pitch, linear density, write current, current overshoot, current overshoot duration and dynamic flying height, for the bottom track, the middle tracks, and the top track. For the same side of disk, the bottom track, middle track and top track may be written by different writers.

In an embodiment, the non-transitory machine-readable medium further includes executable instructions for recording or making available for recording up to about 50 percent of the total recording tracks utilizing one writer in PMR, when there are more than one writers build into one integrated head. In an embodiment, the non-transitory machine-readable medium further includes executable instructions for recording or making available for recording more than 50 percent of the total recording tracks were written wide as compare to top tracks, as the bottom tracks or middle tracks, partially trimmed to be approximately same width as the top tracks.

In an embodiment, the non-transitory machine-readable medium further includes executable instructions for recording or making available for recording more than 50 percent of the total recording tracks were written as the bottom tracks or middle tracks, partially trimmed to be narrow than the top tracks. In an embodiment, the non-transitory machine-readable medium further includes executable instructions for rewrite the top track, bottom track and upper most middle tracks directly when there is no other user data on the tracks above the track to be rewritten.

In an embodiment, the non-transitory machine-readable medium further includes executable instructions for writing a bottom track of a recording media under an optimal writing configurations, the instructions further include code for positioning another bottom track at a predetermined distance from the first bottom track and write that bottom track under an optimal writing configurations. Then write middle tracks in between bottom tracks, with each track written partially trim the previously written tracks and use optimized write configuration determined during the drive test. Then write the top track after both sides of the middle tracks were written. In an embodiment, the percentage of track width being trimmed for different bottom and middle tracks can be different, depend on drive data format arrangement or ATI requirement. In an embodiment using HAMR, laser power is one of the primary writing configurations to be varied to achieve optimal recording configuration. In another embodiment, using PMR, more than one writers maybe used and write current, current overshoot and current overshoot duration is optimized to achieve optimal configuration. In another embodiment, only one writer in PMR is used, and top track will not be written narrower as compare to the bottom and middle tracks.

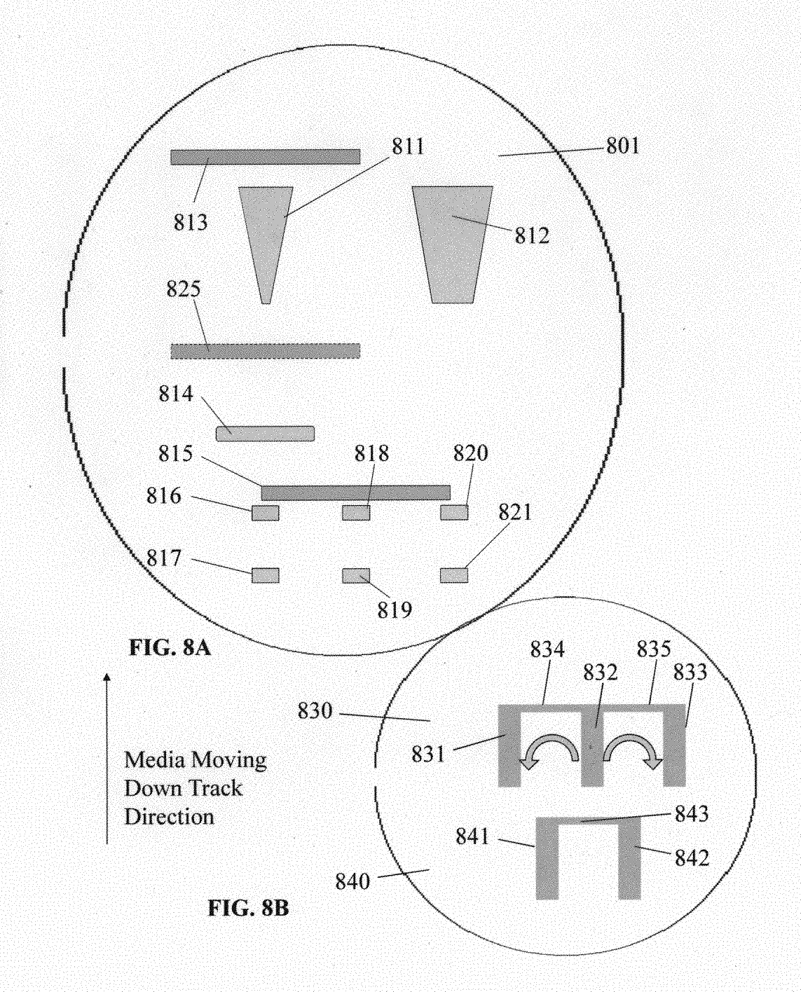

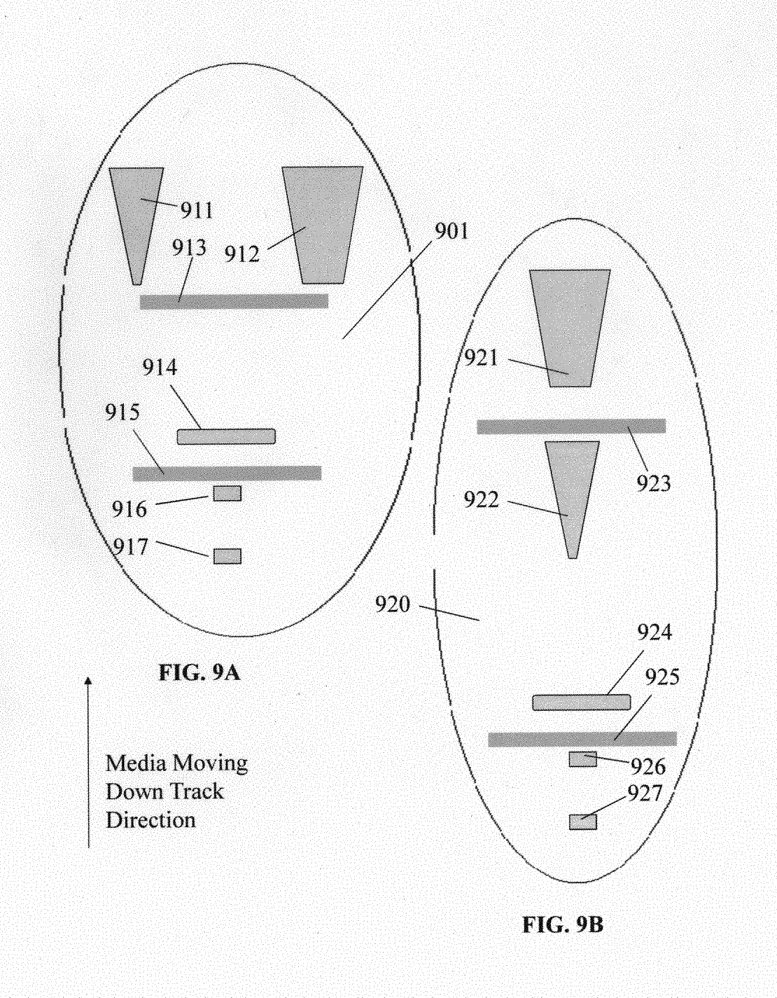

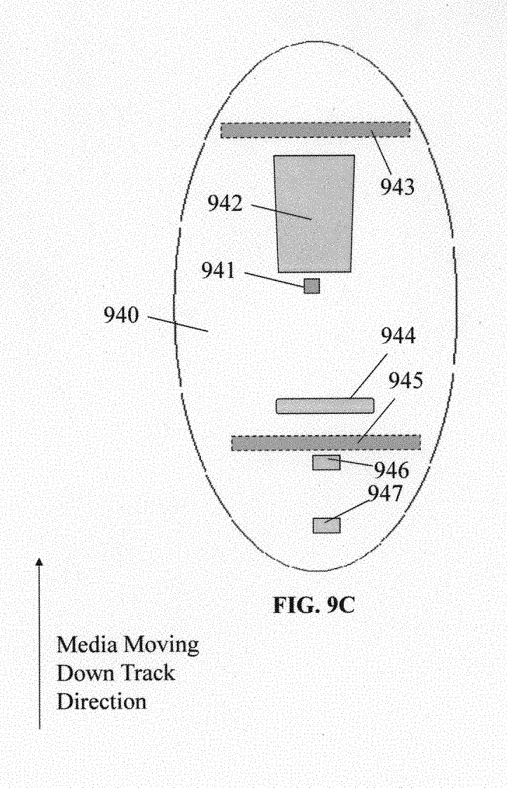

FIG. 8A is an air bearing surface (ABS) view of a perpendicular recording head components of a system that executes methods of an embodiment, where the top track is written with different width as compare to the bottom and middle tracks. As noted earlier, to illustrate relative position and its alignment relation: the write pole is used to represent the writer location and neglect shields structure in this figure; the reader junction is used to represent the reader location and neglect the reader shields structure in this figure, the heater heating element where most heat is generated is used to represent the heater location and neglect the electric contact or lead, the temperature active sensing element expose to ABS is used to represent the temperature sensor location and neglect the electric contact. The detailed design of each element may vary, depend on the particular drive requirements. For an integrated head includes writers, readers, heaters and temperature sensor, the most critical aspect is how each component module align to each other. FIGS. 8-9 all use this definition to represents the relative position among these elements. Different alignment condition among writers, readers, heaters and temperature sensor become critical.

In one embodiment as shown in FIG. 8A, two writers, location are represented by the write pole 811 and 812, are aligned in the cross track direction. The typical separation between two writers 811 and 812 is a few micrometers to allow physical and magnetic separation, such that the writer 811 and 812 can be operate independently. One writer heater 813 may be used during the write process to ensure the write pole 811 is close to the media surface. Alternatively, the writer heater 813 may extend in cross track direction or to align with writer 812 to enable low flying height for writer 812 in the write process. The down track alignment of writer heater 813 can be adjust depend on the detailed head design, in one embodiment, the writer heater can be located below the write pole, as shown at the location 825. Note that writer heater is not exposed at the ABS, but typically recessed by several micrometers away from ABS, as illustrated in FIG. 2D.

In one embodiment, two readers 816 and 817 are aligned to one of the writers write pole in down track direction. An optional reader heater 815 typically is located next to one of the readers but recessed from the ABS. For the reader location align to 816 and 817, the heater location is optimally aligned to read 816 and write 811 heads. In another embodiment, two readers 818 and 819 aligned substantially in down track direction, a few micrometers away from the write pole. In the cross track direction, both readers reside between the writer 811 and 812 as shown in place of 818 and 819. The reader to writer separation in down track direction is typically a few micrometers. In this embodiment, the reader heater 815 is align to the reader 818 and 819. In an embodiment, the readers are aligned in the cross track direction, such as a head has two readers at 816 and 820 or 821. One of the readers 816 is aligned in down track direction to one of the writers 811, and another reader 820 is aligned to writer 812 in down track direction. For both readers aligned in down track direction, multiple play back signal maybe collected for a given track, and ISI and ITI cancellation can be used to improve recording system signal to noise ratio.

In another embodiment, there is only one reader and that reader is aligned in down track direction with one of the writers, such as in location 816 or 820, or can be locate at 818, in between the writers 811 and 812 in the cross track direction. In another embodiment, there are more than one readers and the readers located among location 816, 817, 818, 819, 820, 821 in any combination. In another embodiment, the temperature sensor 814 is located at the ABS and next to the reader 816 or 818 within a couple of micrometers.

FIG. 8B is an illustration of the heater 831 and writer coil electric contact method that executes methods of an embodiment where each individual writer or heater heating element needs to be energized independently. Conventional heater or writer coil as represented in 840 has two contact pads (electric leads) 841 and 841 respectively. The active heating element for heater 843, typically have a much reduced cross section area and a much higher resistance as compare to the contact pads and leads, will generate heat when an electric current passing through. This heat will cause surrounding area to have an elevated temperature, expand and push the writer to be close to the media surface and create a protrusion profile. The active heating element is labeled as 843. The typical head will have a well-defined protrusion profile in order to balance the heater efficiency and head mechanical stability. Too large or too small contact area will cause performance and reliability issue. Therefore, the heating element 843 is carefully design and optimized for each product to create ideal protrusion profile. For blocked magnetic recording, the recording head may want to generate different protrusion profile for each head, when there are more than one writers and readers.

In an embodiment, the heater 830 may have three contact pads or leads 831, 832 and 833 respectively and consist of two active heating element 834 and 835. When in operation, the shared leads 832 may have electric current passing through, to 831 or 833. Depend on which part has current passing through, the heater may push different part of the head to be the close point with respect to the media. For example, if heating element 834 is aligned in down track direction with respect to the writer 811 in FIG. 8A, and heating element 835 is aligned in down track direction with respect to the writer 812 in FIG. 8A, then energize 834 will push writer 811 to be in close point with respect to media, and energize 835 will push writer 812 to be in close point with respect to media. In another embodiment, the element 830 represent writer coils when there is more than one writer integrated into recoding head. In this way, contact pads 831, 832 and 833 are used and 834 and 835 represents the writer coils that drive each writer, for example, writers 811 and 812 as shown in FIG. 8A. In this way, only three contact pads 831, 832 and 833 respectively are needed and depend on the write current path, different writers are energized at a given time. In another embodiment, both writer currents and heaters currents can be generated simultaneously if parallel writing is needed. The driver current waveforms are predetermined and come with the combination of written in data sequence. In another embodiment, two recording heads can be mounted separately, on two different HGAs.

In an embodiment, the two writers in PMR head can be different in terms of write pole width, front shield gap, side shield gap, yoke width, write pole shape or the writer break point as well as ABS shape, such as the wall angle as illustrated in FIG. 2D-2F. In another embodiment, one of the writers may not have a side shield. In an embodiment, one of the writers 811 is used for in drive servo write. In an embodiment, one of the writers 812 is used for in drive servo write. In an embodiment, one of the readers, for example 816, is used for in drive servo read back process to determine the reader and writer position while the other reader is not used. In another embodiment, two or more readers are used to read back servo information and to determine position information.

FIG. 9A is an ABS view of another perpendicular recording head components of a system that executes one of the preferred methods of an embodiments. Recording head 901 consists of two writers represented by 911 and 912 with different write pole width, a writer heater 913 close to the write pole in down track direction, but recessed from the ABS by a few micrometers, two readers 916 and 917 aligned in down track direction, a reader heater 915 next to the readers in down track but recessed a few micrometers from ABS and a temperature sensor 914 close to the readers and at or near the ABS. In this particular example, readers and heaters are aligned in down track direction while reside between two writers in cross track direction. In one embodiment, the heater 913 can have three contact pads as illustrated as heater 830 in FIG. 8B.

FIG. 9B is an ABS view of another perpendicular recording head components of a system that executes an embodiment of BMR. The recording head 920 includes two writers 921 and 922 aligned in down track direction, a writer heater 923 close to the writer in down track, but recessed from ABS, two readers 926 and 927 aligned in down track direction, a reader heater 925 next to the readers in down track but recessed from ABS and a temperature sensor close to the readers, at or close to ABS. In another embodiment, the recording head consist of components as shown as 920 in FIG. 9B, but only with one heater. In another embodiment, the recording head consist of components as shown as 920 in FIG. 9B, but only with one reader. In another embodiment, one of the writers 922 may not have a side shield. In an embodiment, one of the writers 921 is used for in drive servo write. In an embodiment, one of the writers 922 is used for in drive servo write. In an embodiment, one of the readers, for example 926, is used for in drive servo read back process to determine the reader and writer position while the other reader is not used. In another embodiment, two or more readers 926 and 927 are used to read back servo information and to determine position information.

FIG. 9C is an ABS view of a HAMR head of a system that executes an embodiment of BMR. As described in FIG. 2C, for heat assisted magnetic recording (HAMR), typically a laser is mounted and generates light, through the waveguide and eventually focused to the near field transducer (NFT). The location of NFT peg 941 is shown in FIG. 9C, with a write pole 942 next to NFT 941 and above NFT, the writer heater 943 is close to the writer 942 but recessed from the ABS. Below writer and NFT, two readers 946 and 947 is substantially align to the NFT 941 in the down track direction. A reader heater 945 is close to the read heads but recessed from the ABS. A temperature sensor 944 is close to the readers and exposed at the ABS. Different write width is obtained primarily by changing the laser power used during the write process. Other write configurations such as: laser current waveform, writer current, writer current overshoot, writer current overshoot duration, heater power and heater current waveform are optimized to get best ADC, performance and reliability. In another embodiment, only one reader 946 is built for a HAMR head 940 to achieve BMR. In another embodiment, only one heater is used for a HAMR head 940 to achieve BMR.

The NFT, typically has an energy radiation end, absorbs optical energy and couple the electric magnetic energy into the media as it gets close to the media surface, through the energy radiation end, typically defined as NFT peg 941. Due to the requirements to maintain high coupling efficiency and low power loss, the NFT peg can be in solid rod shape based on plasmonic materials such as Au, Ag, Cu or alloys, or it can be based on core-shell structure where the center of the peg may consist of other transition or basic metallic materials such as Ta, W, Re, Os, Mo, Tc, Ru, Rh, Ir, Pt, Pd, Mn, Fe, Co, Ni and their alloys to improve hardness such that the reliability of the head can be improved.

The embodiments were chosen and described to best explain the principles of the invention and its practical application to persons who are skilled in the art. As various modifications, could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

Modifications and variations may be made to the disclosed embodiments while remaining within the spirit and scope of the method, system and apparatus. The implementations described above and other implementations are within the scope of the following claims.

I claim:

1. A blocked magnetic recording method with the recorded data on a magnetic media, where the data tracks can be labeled as top, middle and bottom tracks, and in the write process, the bottom track is written before middle and top tracks next to it; the middle tracks are written, partially trim the previously written tracks from one side, before the top track next to the middle tracks.

2. The method to achieve blocked magnetic recording of claim 1, where in the middle tracks close to the bottom tracks is written before the middle tracks away from the bottom tracks.

3. The method to achieve blocked magnetic recording of claim 1, where in the top tracks and the bottom tracks have different track width as compare to the middle tracks.

4. The method to achieve blocked magnetic recording of claim 3, where in the different write width is obtained by changing one or more of the write configurations from: laser power, heater power, heater waveform, write current, write current overshoot or write current overshoot duration.

5. The method to achieve blocked magnetic recording of claim 3, where in the different write width is obtained by using different write heads.

6. The method to achieve blocked magnetic recording of claim 1, where in the top tracks and the bottom tracks width are different.

7. The method to achieve blocked magnetic recording of claim 1, where in the number of middle tracks between top and bottom tracks can be same or different in different data band, preferred to be from 0 to 100.

8. A blocked magnetic recording method with the recorded data on a magnetic media, where the data tracks can be grouped into bands, each band includes more than one tracks and within each band, the data tracks can be labeled as top, middle and bottom tracks, where the neighboring bands have tracks partially trimmed from opposite sides.

9. The method to achieve blocked magnetic recording configuration of claim 8, where the number of middle tracks on one side of the bottom track is 0.

10. The method to achieve blocked magnetic recording configuration of claim 8, where in the percentage of bottom track being trimmed by middle or top tracks is less than the percentage of middle tracks being trimmed by neighboring middle track within the same band.

11. The method to achieve blocked magnetic recording configuration of claim 8, where in the percentage of top track being trimmed by the other top track from neighboring band is less than the percentage of middle tracks being trimmed by other middle tracks.

12. The method to achieve blocked magnetic recording configuration of claim 8, where in the top tracks from neighboring band partially overlap with each other.

13. The method to achieve blocked magnetic recording configuration of claim 8, where in each band of data can be directly rewritten or updated.

14. The method to achieve blocked magnetic recording configuration of claim 16, where in rewrite new data into different band involve read verification process.

15. A magnetic recording method including an integrated magnetic recording head with one or two writers, one or two read sensors, at least one temperature sensor and at least one heater is energized during read and write processes to enable low head media separation. The recorded data is on a magnetic medium, where the data tracks can be labeled as top, middle and bottom tracks. In the write process, the bottom track always written before the middle track next to it, the middle track is written before the top track next to it.

16. The method to achieve magnetic recording of claim 15, where the number of middle track is 0. The bottom track is written before the top track next to it.

17. The method to achieve magnetic recording of claim 15, where the drive also includes written tracks using shingled magnetic recording or conventional magnetic recording.

18. The method to achieve magnetic recording configuration of claim 15 where the write configurations are determined and optimized by different region and before the product reach customer.

19. The method to achieve magnetic recording of claim 15, where different tracks were written using different writer heads on the same slider.

20. The method to achieve magnetic recording of claim 15, where different tracks were written using different writer heads on different sliders.
